(19) United States
(12) Patent Application Publication
(10) Pub. No.: US 2010/0168999 A1
(43) Pub. Date: Jul. 1, 2010

(54) COMPUTER READABLE MEDIUM FOR STORING INFORMATION DISPLAY PROGRAM, INFORMATION DISPLAY APPARATUS AND INFORMATION DISPLAY METHOD

(75) Inventors: Takefumi Horie, Kawasaki (JP); Takayuki Yamaji, Kawasaki (JP); Kazutoshi Sakaguchi, Kawasaki (JP); Kotaro Teranishi, Kawasaki (JP); Makoto Morioka, Kawasaki (JP); Takashi Hirano, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/638,403

(22) Filed: Dec. 15, 2009

(30) Foreign Application Priority Data
Dec. 26, 2008 (JP) 2008-334418

(51) Int. Cl. G01C 21/00

(52) U.S. Cl. 701/201

(57) ABSTRACT

A computer readable medium for storing information display programs causing a computer communicating with a communication apparatus provided at the entry or exit at an entrance/exit point where a user gets on or off a transportation system to perform a display method, the display method include: detecting that the user has left the exit of the current entrance/exit point through the communication between a communication apparatus; identifying the next entrance/exit point to the current entrance/exit point among the entrance/exit points within the route; acquiring map showing the route from the current entrance/exit point to the next entrance/exit point identified by the identifying the next entrance/exit point to the current entrance/exit point; and controlling a display screen of the computer so as to display the map showing the route from the current entrance/exit point to the next entrance/exit point acquired by the acquiring map.

### CROSS REFERENCE TO RELATED APPLICATION

This application is based upon and claims the benefit of priority from the prior Japanese Patent Application NO. 2008-334418 filed on Dec. 26, 2008, the entire contents of which are incorporated herein by reference.

### FIELD

The embodiment discussed herein are related to a computer readable medium for storing information display programs, information display apparatuses, and information display methods.

### BACKGROUND

Hitherto, technologies have been disclosed that acquire information from a fixed terminal provided in a train, transportation facilities, or the like, and read a journey history from an IC card ticket to calculate the fare or manages journey histories.

### [Patent Document 1]

### Japanese Laid-open Patent Publication No. 2008-117154

### [Patent Document 2]

### Japanese Laid-open Patent Publication No. 2004-48193

### [Patent Document 3]

### Japanese Laid-open Patent Publication No. 10-31418

However, the technologies in the past have difficulties that, in an area where a GPS is not available, it is difficult for a user to search for a route and route guidance is not available to a user. Even when route search and/or route guidance are available, a user is forced to operate a terminal and input data for the route search or route guidance, which is not convenience. Another difficulty may arise when a user who is trying to change transportation systems may lose his/her way at an unfamiliar and unknown place with intricate routes.

### SUMMARY

According to an aspect of the embodiments, an information display method in which a computer communicating with a communication apparatus provided at the entry or exit at an entrance/exit point where a user gets on or off a transportation system includes: detecting that the user has left the exit of the current entrance/exit point through the communication between a communication apparatus provided at the exit of the current entrance/exit point where the computer is within the communication area and the computer, among the communication apparatuses provided at the exits of the entrance/exit points within a route through the entrance/exit points; if the detecting step detects that the user has left the current entrance/exit point, identifying the next entrance/exit point to the current entrance/exit point among the entrance/exit points within the route; acquiring map illustrating the route from the current entrance/exit point to the next entrance/exit point identified by the identifying the next entrance/exit point to the current entrance/exit point through the communication between the communication apparatus provided at the exit of the current entrance/exit point and the computer; and controlling a display screen of the computer so as to display the map illustrating the route from the current entrance/exit point to the next entrance/exit point acquired by the acquiring map illustrating the route from the current entrance/exit point to the next entrance/exit point.

The object and advantages of the embodiments will be realized and attained by means of the elements and combinations particularly pointed out in the claims.

It is to be understood that both the foregoing general description and the following detailed description and are exemplary and explanatory and are not restrictive of the embodiments, as claimed.

### BRIEF DESCRIPTION OF DRAWINGS

FIG. 1 is an explanatory diagram illustrating schematic routes;

FIG. 2 is an explanatory diagram illustrating an IC (or integrated circuit) card according to an embodiment;

FIG. 3 is an explanatory diagram (Part 1) illustrating an example of map to be displayed on the IC card according to the embodiment;

FIG. 4 is an explanatory diagram (Part 2) illustrating an example of map to be displayed on the IC card according to the embodiment;

FIG. 5 is a block diagram illustrating a hardware configuration of the IC card 200 according to the embodiment;

FIG. 6 is a block diagram illustrating a hardware configuration of a communication apparatus that communicates with the IC card according to the embodiment;

FIG. 7 is a block diagram illustrating a functional configuration of the IC card according to the embodiment;

FIG. 8 is a block diagram illustrating a functional configuration of a communication apparatus according to the embodiment;

FIG. 9 is an explanatory diagram illustrating a sequence between the communication apparatus and the IC card according to the embodiment;

FIG. 10 is an explanatory diagram illustrating the map having the route from the entrance/exit point where a user has left to the next entrance/exit point according to the embodiment;

FIG. 11 is an explanatory diagram illustrating the direction-of-travel information displayed on a display screen of the IC card according to the embodiment;

FIG. 12 is an explanatory diagram illustrating the direction-of-travel information displayed on the display screen of the IC card according to the embodiment;

FIG. 13 is a block diagram illustrating a functional configuration of communication-apparatuses-between-the-points according to the embodiment; and

FIG. 14 is an explanatory diagram illustrating a sequence between one of the communication-apparatuses-between-the-point and the IC card according to the embodiment.

### DESCRIPTION OF EMBODIMENT

With reference to the attached drawings, the information display program, information display apparatus and information display method and information display program, information display apparatus and information display method according to a preferred embodiment will be described in detail.

### [Schematic Routes]

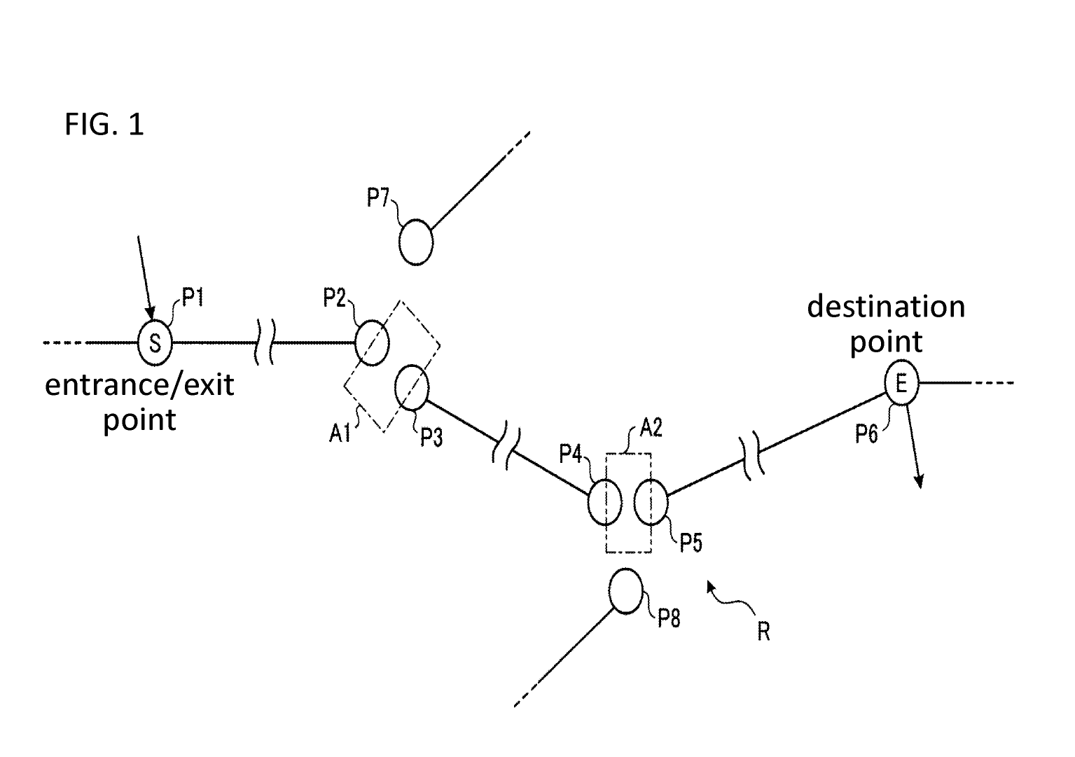

FIG. 1 is an explanatory diagram illustrating schematic routes. FIG. 1 includes nodes indicated by circles, which are entrance/exit points P# (where # is a number) where a user gets on or off a transportation system, such as a station, a bus stop, an airport, and a harbor and links between the nodes, which are routes between entrance/exit points P#. It is assumed here that the route R is a route where the entrance/exit point P1 is the origin point, the entrance/exit points P2 to P5 are via-points, and the entrance/exit point P6 is the destination point. Notably, the entrance/exit point P7 off the route R may be an entrance/exit point in the neighborhood (such as within a walkable area) of the entrance/exit point P2 or P3. Similarly, the entrance/exit point P8 may be an entrance/exit point in the neighborhood (such as within a walkable area) of the entrance/exit points P4 and P5.

When a user follows the route R, he or she may change the transportation system between entrance/exit points P2 and P3 or between entrance/exit points P4 and P5. The actual route from entrance/exit point P2 (or P4) to the entrance/exit point P3 (or P5) may be required to reach the entrance/exit point P3 (or P5). A positional information service using a GPS (or global positioning system) of cellular phones does not provide the actual route from the entrance/exit point P2 (or P4) to the entrance/exit point P3 (or P5) at locations where the GPS are not available (or almost not available) such as within subway cars and facility.

According to this embodiment, information display or information supply is implemented that acquire map on an area A1 between the entrance/exit points P2 and P3 or an area A2 between the entrance/exit points P4 and P5 where a user changes the transportation system, without operations by the user.

### [IC Card]

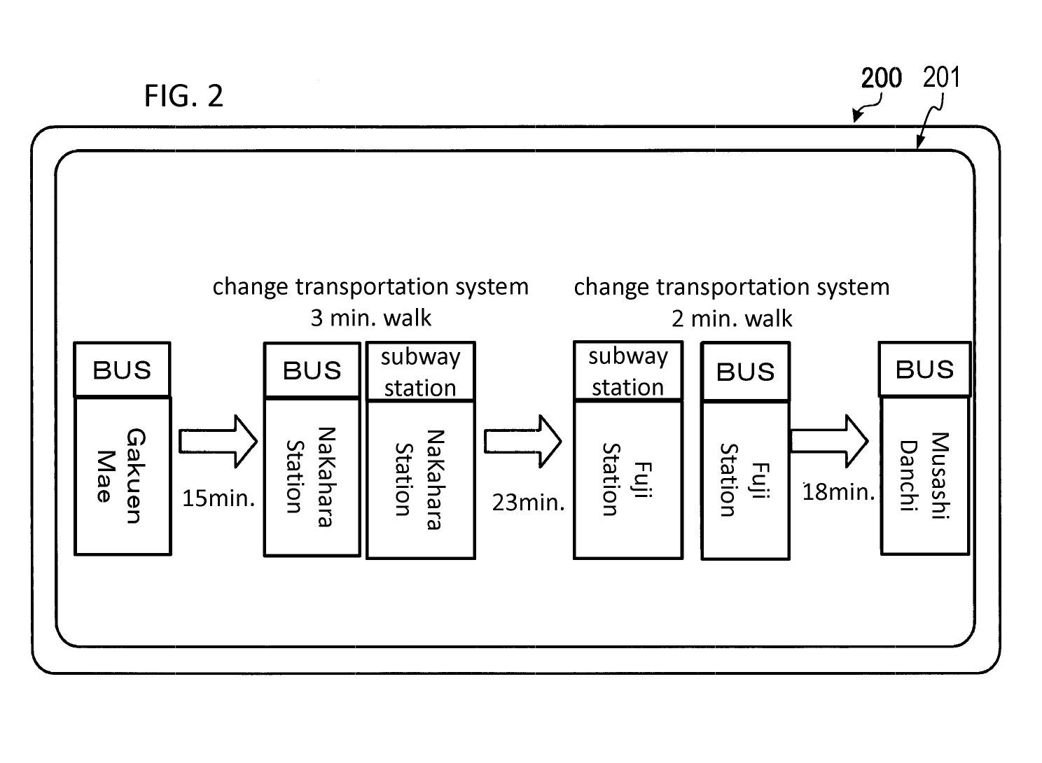

FIG. 2 is an explanatory diagram illustrating an IC (or integrated circuit) card according to this embodiment. An IC card 200 has on its surface, a display screen 201 configured by electronic paper, for example. In FIG. 2, the display screen 201 displays detail information on the route R to a destination point of a user. Here, on the display screen 201 in FIG. 2, the bus stop “Gakuen Mae” corresponds to the entrance/exit point P1. The bus stop “Nakahara Station” corresponds to the entrance/exit point P2. The subway station “Nakahara Station” corresponds to the entrance/exit point P3. The subway station “Fuji Station” corresponds to the entrance/exit point P4. The bus stop “Fuji Station” corresponds to the entrance/exit point P5. The bus stop “Musashi Danchi” corresponds to the entrance/exit point P6.

The route R may be input to the IC card 200 by writing to the IC card 200 the route R searched by using a personal computer (not illustrated) of a user or writing to the IC card 200 the route R searched by using a terminal prepared in transportation facility. The IC card 200 is a device that performs non-contact communication with an automatic ticket gate in a station or a fare adjustment machine in a bus to adjust the fare, like existing non-contact IC cards 200.

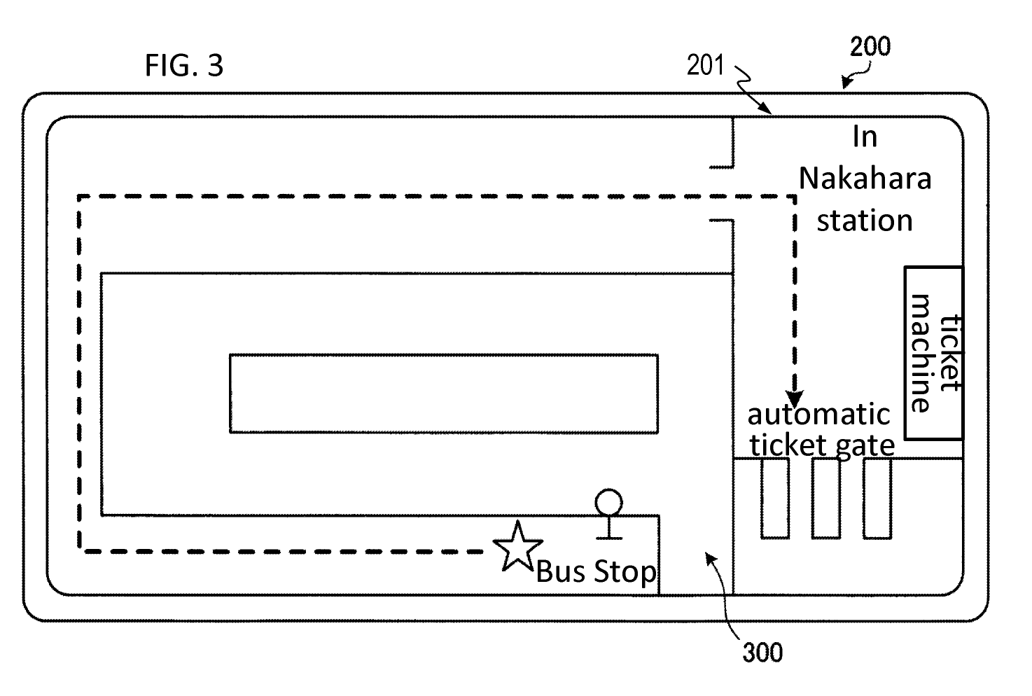

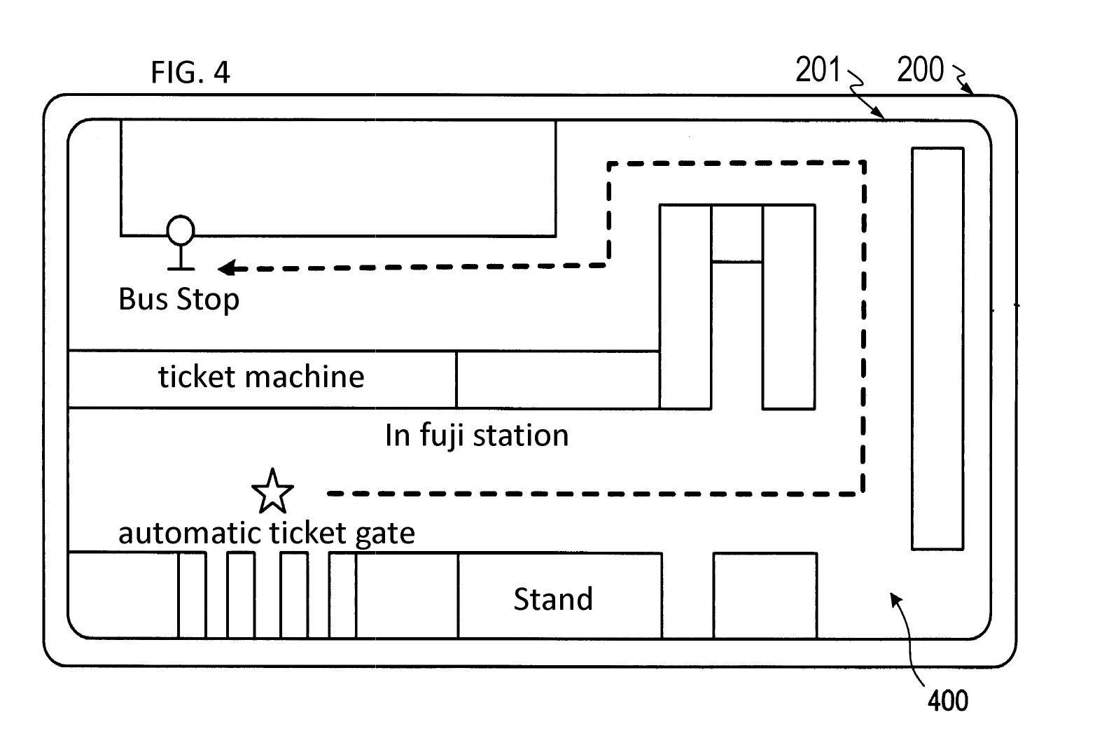

FIG. 3 and FIG. 4 are explanatory diagrams illustrating an example of map to be displayed on the IC card 200 according to this embodiment. In FIG. 3, the map 300 on the area A1 illustrated in FIG. 1 is displayed. In FIG. 4, the map 400 on the area A2 illustrated in FIG. 1 is displayed. Notably, in the map in FIG. 3, the star indicates a position where a user gets off, and the dashed line indicates the route to the next entrance/exit point that a user is supposed to follow.

### [Hardware Configuration]

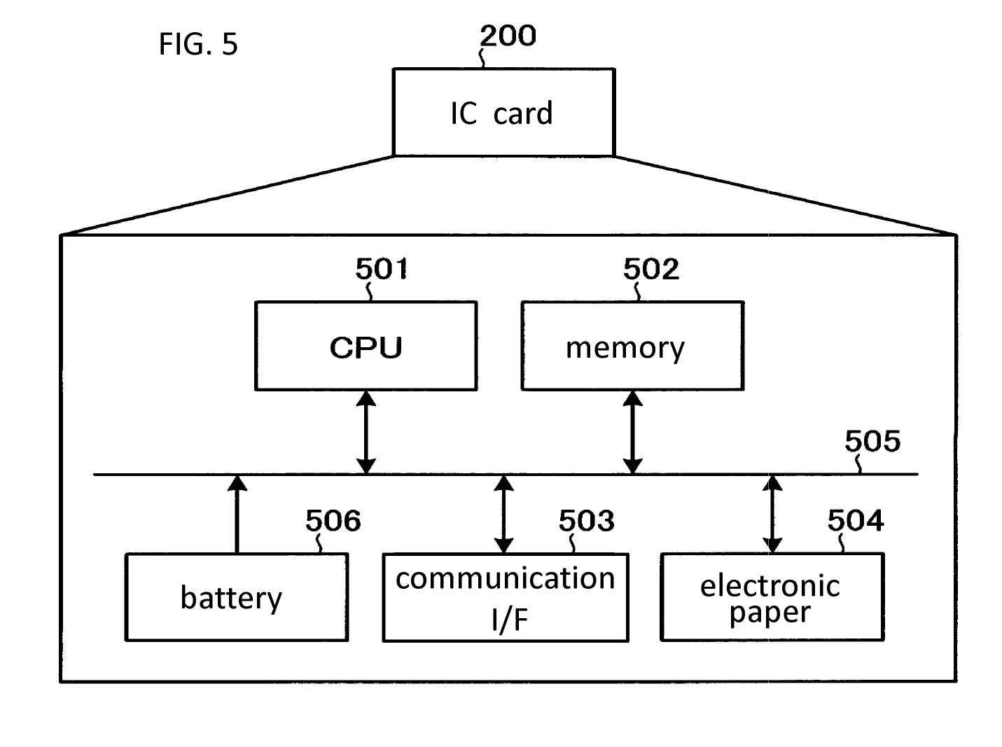

FIG. 5 is a block diagram illustrating a hardware configuration of the IC card 200 according to this embodiment. In FIG. 5, the IC card 200 has a configuration in which a CPU (or central processing unit) 501, a memory 502, a communication I/F (or interface) 503 and an electronic paper 504 connect to the bus 505. The CPU 501 controls the entire IC card 200. The memory 502 may be a ROM (read-only memory), a RAM (random access memory), or a flash memory, for example, and stores programs and/or information. A battery 506 supplies power to the IC card 200.

The memory 502 is also used as a work area for the CPU 501. The communication I/F 503 controls the transmission and reception of data to and from an external device. The electronic paper 504 has the display screen 201 illustrated in FIG. 2 to FIG. 4 and displays information saved in the memory 502. Notably, without limiting to the electronic paper 504, a transmissive liquid crystal or organic EL (electro-luminescence) display may be used.

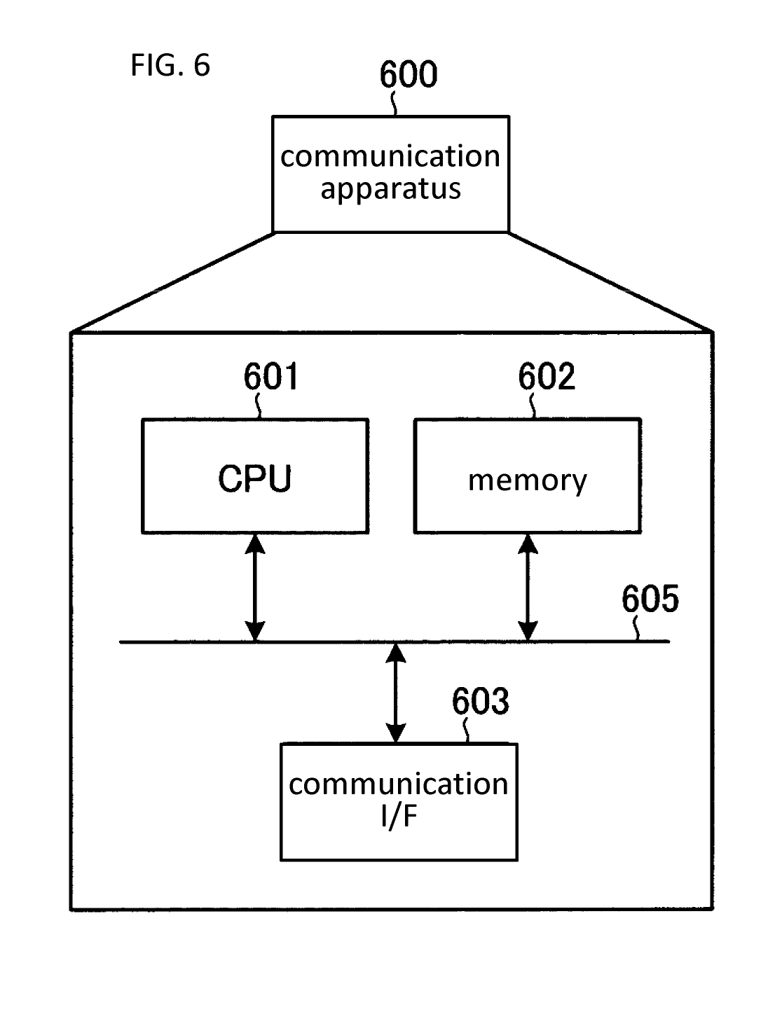

FIG. 6 is a block diagram illustrating a hardware configuration of a communication apparatus that communicates with the IC card 200 according to this embodiment. A communication apparatus 600 is a communication apparatus provided at the entrances or exits at the entrance/exit points P1 to P6. For example, if the entrance/exit point is a station, the communication apparatus 600 is internally installed in an automatic ticket gate. If the entrance/exit point is (within) a bus or a bus stop, the communication apparatus 600 is internally installed in a fare adjustment machine in the bus. Alternatively, the communication apparatus 600 may be provided at any entrance/exit point in accordance with the usage situations users might face.

In FIG. 6, the communication apparatus 600 includes the connection among the CPU 601, the memory 602 and the communication I/F 603 via a bus 605. The CPU 601 is responsible for entire control over the communication apparatus 600. The memory 602 may be a ROM, a RAM or a flash memory, for example, and stores programs and/or information. The memory 602 is also used as a work area for the CPU 601. The communication I/F 603 controls the transmission and reception of data to and from the IC card 200.

### [Functional Configuration of IC Card 200]

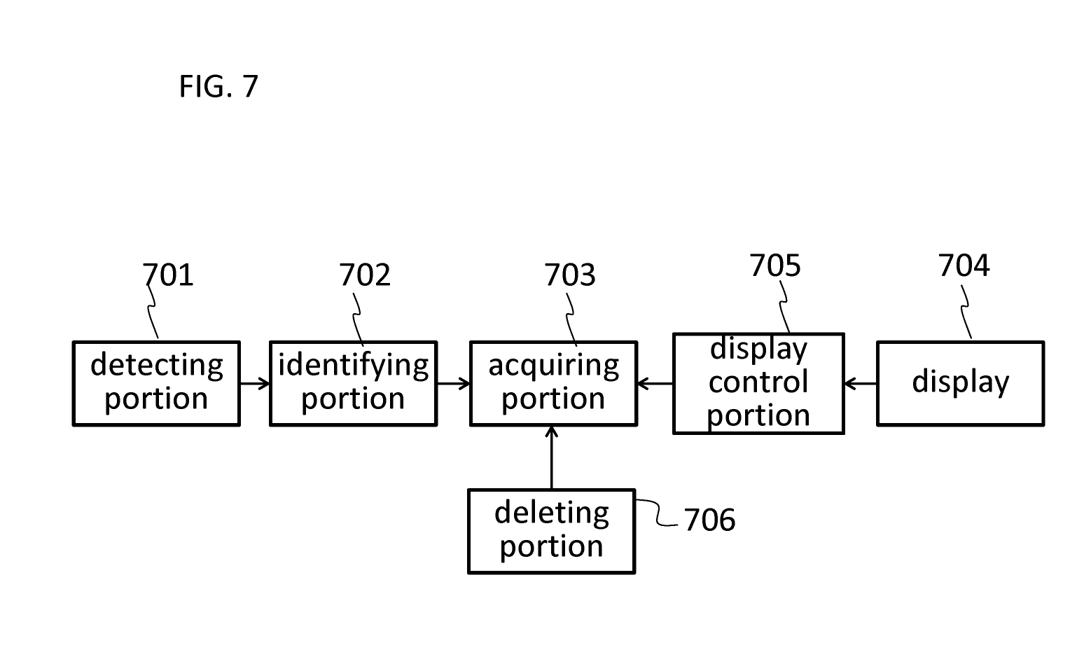

FIG. 7 is a block diagram illustrating a functional configuration of the IC card 200 according to this embodiment. The IC card 200 includes a detecting portion 701, an identifying portion 702, an acquiring portion 703, a display portion 704, a display control portion 705, and a deleting portion 706. The detecting portion 701, identifying portion 702, acquiring portion 703, display control portion 705 and deleting portion 706, more specifically, may implement their functions by causing the CPU 501 to execute the corresponding programs stored in the memory 502 illustrated in FIG. 5 or through the communication I/F 503. The display portion 704 may implement its function with a display device such as the electronic paper 504 illustrated in FIG. 5.

The detecting portion 701 has a function of detecting that a user has left the exit at the current entrance/exit point through the communication between the communication apparatus 600 provided at the exit of the current entrance/exit point where the IC card 200 is within the communication area and the IC card 200, among the communication apparatuses 600 provided at the exits at the entrance/exit points P1 to P6 on the route R through the entrance/exit points P1 to P6.

More specifically, focusing on the entrance/exit point P2, for example, since the communication apparatus 600 at the entrance/exit point P2 is internally installed in a fare adjustment machine within a bus, the detecting portion 701 detects that a user has left the entrance/exit point P2 (or has gotten off the bus) through non-contact communication with the communication apparatus 600 at the entrance/exit point P2 when the user pays before getting off the bus. Focusing on the entrance/exit point P4, since the communication apparatus 600 at the entrance/exit point P4 is internally installed in an automatic ticket gate in Fuji Subway Station, the detecting portion 701 detects that a user has left the entrance/exit point P4 (or has exited from an automatic ticket gate in Fuji Station) through non-contact communication when the user has left the automatic ticket gate.

The identifying portion 702 has a function of, if the detecting portion 701 detects that the user has left the current entrance/exit point, identifying the next entrance/exit point to the current entrance/exit point among the entrance/exit points P1 to P6 on the route R. More specifically, focusing on the entrance/exit point P2, for example, when the fact that a user has left the entrance/exit point P2, the IC card 200 reads out the next entrance/exit point P3 to the entrance/exit point P2 from the route R saved in the memory 502.

The acquiring portion 703 has a function of acquiring map illustrating the route from the current entrance/exit point to the next entrance/exit point identified by the identifying portion 702 through the communication with the communication apparatus 600 provided at the exit at the current entrance/exit point. More specifically, for example, through non-contact communication with the communication apparatus 600 when a user gets off or leaves an automatic ticket gate, the point information (which will be called next point information) on the next entrance/exit point identified by the identifying portion 702 is transmitted to the communication apparatus 600.

Thus, in the communication apparatus 600, on the basis of the set of the point information on the current entrance/exit point (which will be called current point information) and the next point information, the map illustrating the route from the current entrance/exit point to the next entrance/exit point is extracted from the maps within the memory 502. Then, the IC card 200 receives the extracted map through non-contact communication. For example, if the current entrance/exit point is the entrance/exit point P2, the map 300 illustrated in FIG. 3 is acquired. If the current entrance/exit point is the entrance/exit point P4, the map 400 illustrated in FIG. 4 is acquired.

The display control portion 705 has a function of controlling the display screen 201 (or display portion 704) of the IC card 200 so as to display the map illustrating the route from the current entrance/exit point to the next entrance/exit point acquired by the acquiring portion 703. More specifically, for example, the map acquired by the acquiring portion 703 is rendered on the display screen 201. For example, if the current entrance/exit point is the entrance/exit point P2, the map 300 illustrated in FIG. 3 is displayed on the display screen 201. If the current entrance/exit point is the entrance/exit point P4, the map 400 illustrated in FIG. 4 is displayed on the display screen 201.

The deleting portion 706 has a function of deleting the information acquired by the acquiring portion 703 from the memory 502 within the IC card 200. More specifically, for example, it is assumed that the acquiring portion 703 acquires map illustrating the route from the last entrance/exit point before the current entrance/exit point to the current entrance/exit point prior to the map illustrating the route from the current entrance/exit point to the next entrance/exit point. In this case, the deleting portion 706 deletes the map illustrating the route from the last entrance/exit point to the current entrance/exit point from the memory 502 before the map illustrating the route from the current entrance/exit point to the next entrance/exit point is displayed on the display screen 201.

More specifically, the map 300 illustrated in FIG. 3 is deleted from the memory 502 before the map 400 illustrated in FIG. 4 is displayed. The map 300 may be deleted when the entry to the current entrance/exit point is detected or when the exit from the current entrance/exit point is detected. Thus, only one map may be required to store, which may save the space of the memory.

### [Functional Configuration of Communication Apparatus 600]

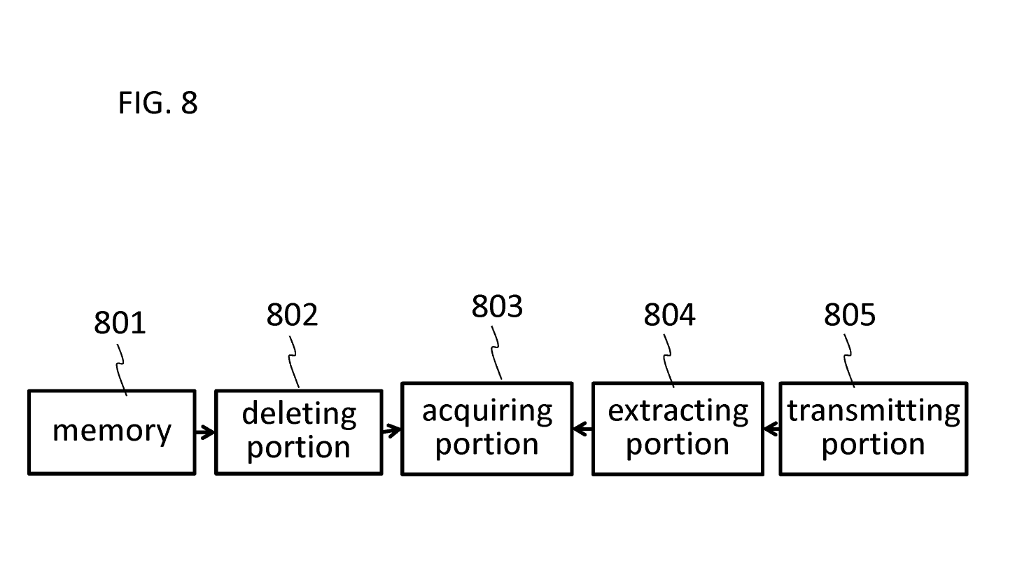

FIG. 8 is a block diagram illustrating a functional configuration of the communication apparatus 600 according to this embodiment. The communication apparatus 600 includes a storage portion 801, a detecting portion 802, an acquiring portion 803, an extracting portion 804, and a transmitting portion 805. The storage portion 801 may implement its function by the memory 502 illustrated in FIG. 6. The detecting portion 802, acquiring portion 803, extracting portion 804 and transmitting portion 805 may implement their functions by causing the CPU 601 to execute the corresponding programs stored in the memory 602 illustrated in FIG. 6 or through the communication I/F 603.

The storage portion 801 has a function of storing map illustrating the route from the entrance/exit point to another entrance/exit point in the neighborhood of the entrance/exit point for the other entrance/exit point. More specifically, for example, the memory 602 in the communication apparatus 600 stores map 300 and 400 illustrated in FIG. 3 and FIG. 4.

The detecting portion 802 has a function of detecting that a user has left the exit at the entrance/exit point through communication with the mobile terminal within the communication area of the communication apparatus 600. More specifically, for example, through non-contact communication with the IC card 200, the fact that a user has left is detected by receiving information on the corresponding entry record from the IC card 200 having the entry record.

The acquiring portion 803 has a function of, if the detecting portion 802 detects that the user has left, acquiring information on the entrance/exit point where the user will pass next through communication with the IC card 200. More specifically, for example, through non-contact communication with the IC card 200, the acquiring portion 803 receives the next-point information from the IC card 200.

The extracting portion 804 has a function of, on the basis of the information on the next entrance/exit point acquired by the acquiring portion 803, extracting map illustrating the route from the entrance/exit point to the next entrance/exit point acquired by the acquiring portion 803 from maps stored in the storage portion 801. More specifically, for example, through non-contact communication with the IC card 200, the extracting portion 804 receives a set of the current-point information and the next-point information. Then, the extracting portion 804 extracts the map illustrating the route from the current entrance/exit point to the next entrance/exit point from the maps within the memory 602.

For example, if the communication apparatus 600 is the communication apparatus 600 at the exit at the entrance/exit point P2, the communication apparatus 600 receives the point information on the entrance/exit point P2 as the current-point information from the IC card 200 and receives the point information on the entrance/exit point P3 as the next-point information. Since the memory 602 in the communication apparatus 600 stores a set of the current-point information and the next-point information in association with the map, the map in association with the set of the current-point information (on P2) and the next-point information (on P3) is extracted from the memory 602.

The transmitting portion 805 has a function of transmitting the map illustrating the route from the entrance/exit point to the next entrance/exit point extracted by the extracting portion 804 to the IC card 200 through non-contact communication with the IC card 200. The transmission causes the extracted map to be written to the memory 502 in the IC card 200 and the map to be displayed on the display screen 201 in the IC card 200. Thus, since a user acquire the map to the next entrance/exit point through non-contact communication between the communication apparatus 600 and the IC card 200 when the user leaves, the user may acquire the route to the next entrance/exit point seamlessly without performing any special operations.

### [Sequence Between Communication Apparatus 600 and IC Card 200]

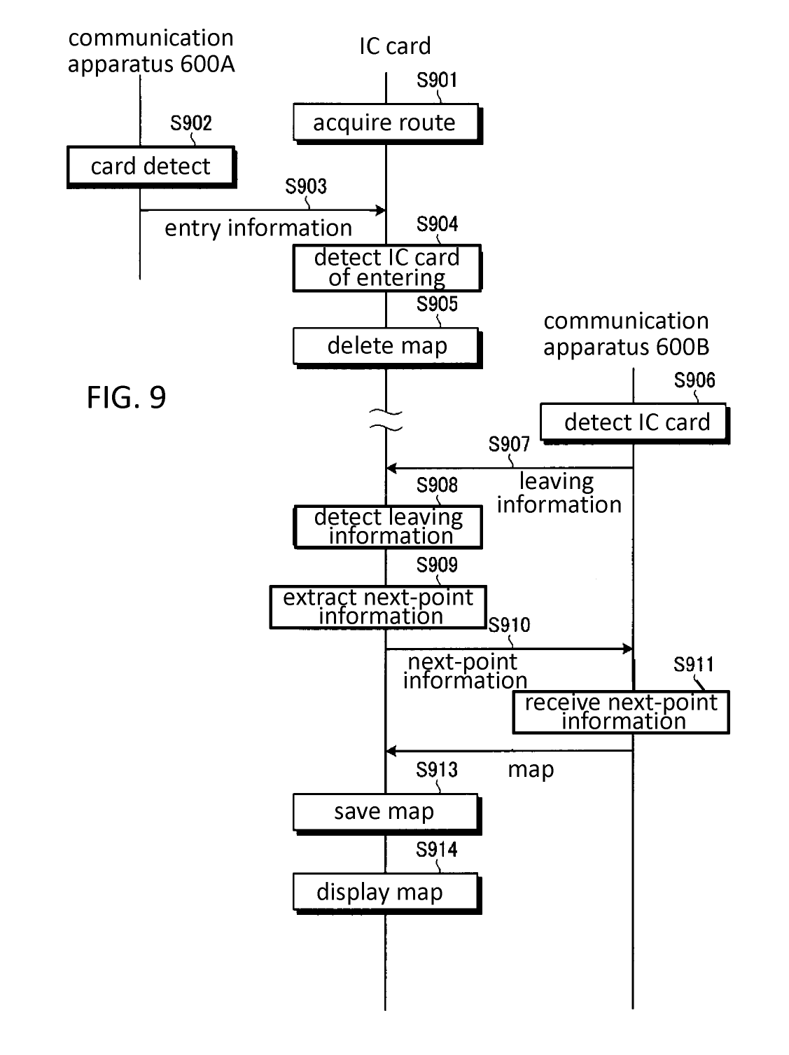

FIG. 9 is an explanatory diagram illustrating a sequence between the communication apparatus 600 and the IC card 200 according to this embodiment. The sequence diagram has a processing routine by a communication apparatus 600A on the left-hand side, where the communication apparatus 600A is the communication apparatus 600 at the source entrance/exit point where a user enters. Similarly, the sequence diagram has a processing routine by a communication apparatus 600B on the right-hand side, where the communication apparatus 600B is the communication apparatus 600 at the destination entrance/exit point where a user leaves.

First of all, in the IC card 200, the route by a user is acquired and is written to the memory 502 (step S901). If the communication apparatus 600A detects that the IC card 200 exists within the communication area of the communication apparatus 600A (step S902), the communication apparatus 600A transmits entry information (such as an entry time, a station that the user boards and a base fare) to the IC card 200 (step S903).

In accordance with the reception of the entry information, the IC card 200 detects that the user of the IC card 200 enters and writes the entry information to the memory 502 (step S904). If at that time the memory 502 already has a map, the map is deleted (step S905). Thus, the map acquired upon leaving may be reserved in a storage area, which may save the space of the memory.

After that, the user carrying the IC card 200 may use a transportation system at the entrance/exit point having the communication apparatus 600A to go to the entrance/exit point having the communication apparatus 600B. When the user leaves the exit at the entrance/exit point having the communication apparatus 600B, the communication apparatus 600B detects that the IC card 200 exists within the communication area of the communication apparatus 600B (step S906). The communication apparatus 600B transmits the leaving information (such as a leaving time, station where the user gets off, and the fare from the station that the user boards to the station where the user gets off) to the IC card 200 (step S907).

In accordance with the reception of the leaving information, the IC card 200 detects that the user of the IC card 200 has left, the leaving information is written to the memory 502 (step S908). At that time, the amount corresponding to the fare from the station where the user boards to the station where the user gets off is subtracted from the electronic money within the memory 502. The IC card 200 in accordance with the detection of leaving extracts the next-point information from the route saved in the memory 502 (step S909). More specifically, the IC card 200 reads out the point information on the next entrance/exit point to the entrance/exit point where the user has left. Then, the IC card 200 transmits the next-point information to the communication apparatus 600B (step S910).

If the communication apparatus 600B receives the next-point information, the communication apparatus 600B extracts the map associated with a set of the point information at the entrance/exit point having the communication apparatus 600B and the received next-point information from the memory 602 (step S911). Then, the communication apparatus 600B transmits the extracted map to the IC card 200 (step S912).

The IC card 200 receives the transmitted map and saves it in the memory 502 (step S913). Then, the saved map is displayed on the electronic paper 504 (step S914). In this way, according to the sequence illustrated in FIG. 9, through the communication with the communication apparatus 600B in leaving the entrance/exit point and in paying the fare, the user may acquire the map from the current entrance/exit point (that is the entrance/exit point where the user gets off) to the next entrance/exit point.

Thus, a user is only required to perform the leaving action to check the route to the destination, without any operation for acquiring map by himself/herself. The map is not distributed without limitation, but the last map is deleted when it is no longer necessary. This may prevent the increase in capacity of the internal memory 502 and therefore the increase in size of the IC card 200.

According to this embodiment, the map illustrating the route from the communication apparatus 600 at the exit at the entrance/exit point to the next entrance/exit point to the entrance/exit point where a user has left is received and is displayed on the IC card 200. In this case, a user who is travelling the route from the entrance/exit point where a user has left to the next entrance/exit point may receive the distribution of the information indicating the direction of travel (which will be called direction-of-travel information), and the information may be displayed on the IC card 200.

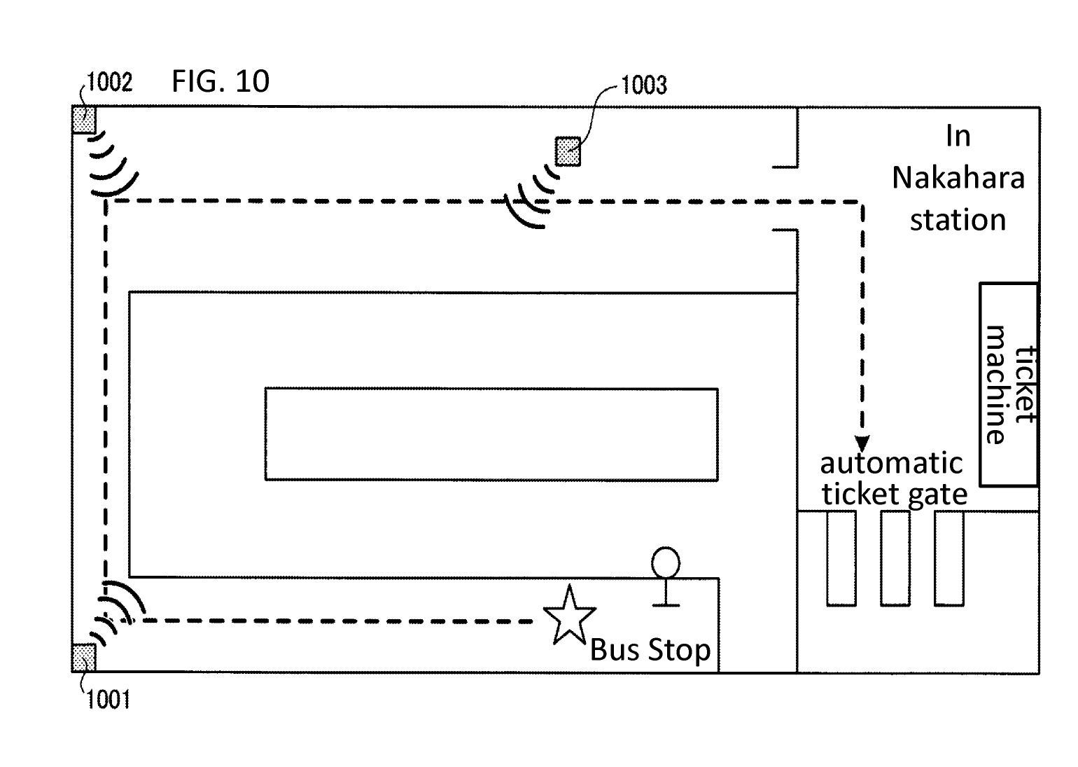

FIG. 10 is an explanatory diagram illustrating the map having the route from the entrance/exit point where a user has left to the next entrance/exit point according to this embodiment. The map in FIG. 10 corresponds to the map illustrated in FIG. 3. The communication apparatuses 1001 to 1003 in FIG. 10 are scattered on the route from the entrance/exit point where a user has left to the next entrance/exit point. According to this embodiment, they are called “communication-apparatus-between-the-points”, for distinction from the communication apparatus 600 at the entry or exit at an entrance/exit point.

The communication-apparatuses-between-the-points 1001 to 1003 are provided at a neighboring entrance/exit point of the entrance/exit points where a user gets on and off a transportation system, such as a station, a bus stop, an airport and a harbor and communicates with a mobile terminal that the user carries. Here, the term “neighboring” refers to a range where a user may walk and more specifically refers to, for example, one train section for the railroads or the range of one to two or three bus stops for buses.

In FIG. 10, the three communication-apparatuses-between-the-points 1001 to 1003 are provided on the route. If the IC card 200 enters to the communication area, the corresponding one of the communication-apparatuses-between-the-points 1001 to 1003 transmits the direction-of-travel information to the IC card 200 through non-contact communication. When the IC card 200 receives the direction-of-travel information, the IC card 200 displays the received direction-of-travel information on the display screen 201 of the IC card 200.

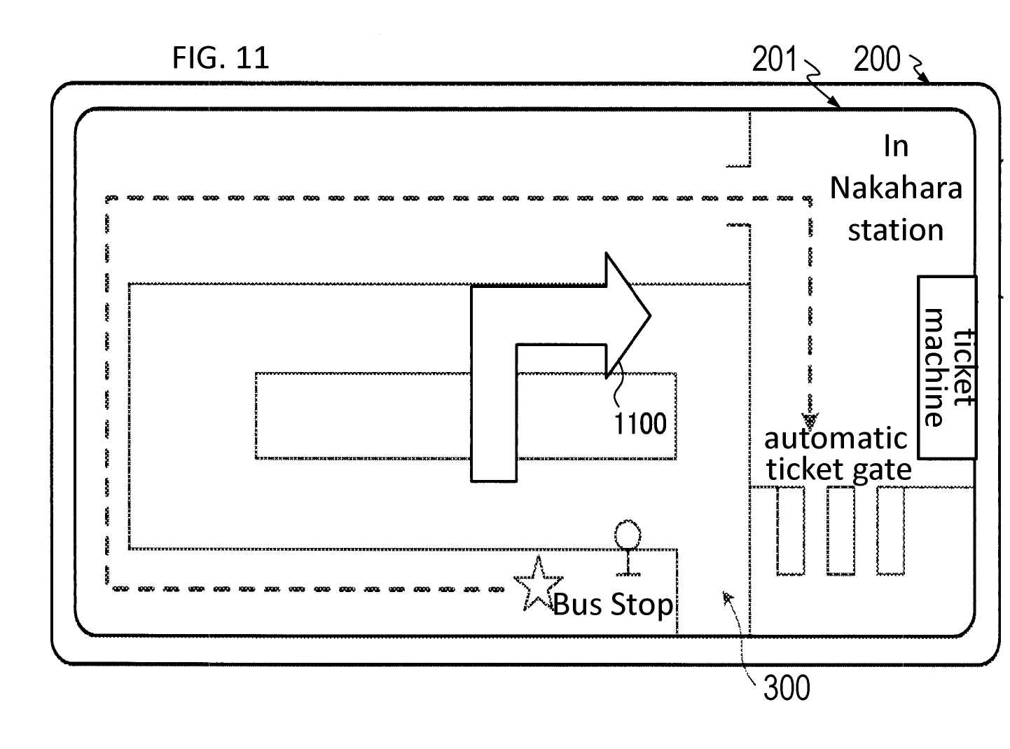

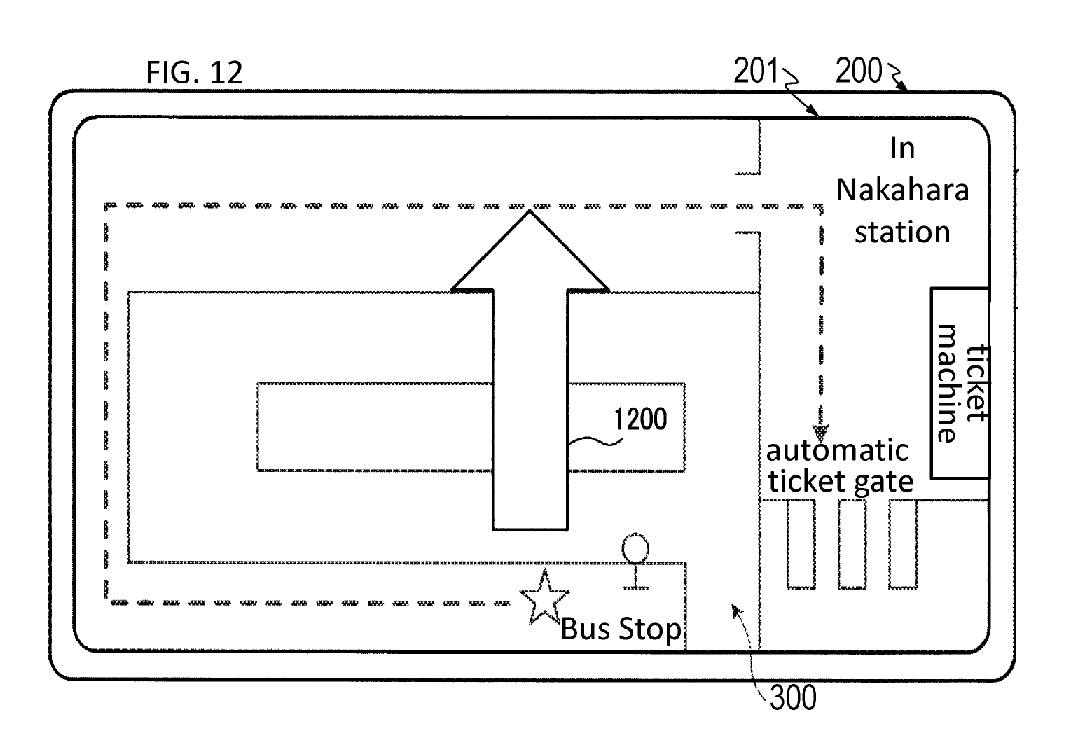

FIG. 11 and FIG. 12 are explanatory diagrams illustrating the direction-of-travel information displayed on the display screen 201 of the IC card 200 according to this embodiment. In FIG. 11, the direction-of-travel information 1100 transmitted from the communication-apparatuses-between-the-points 1001 and 1002 is displayed. In FIG. 12, the direction-of-travel information 1200 transmitted from the communication-apparatus-between-the-points 1003 is displayed.

### [Functional Configuration of Communication-Apparatuses-Between-the-Points 1001 to 1003]

Next, a functional configuration of the communication-apparatuses-between-the-points 1001 to 1003 will be described. Since the hardware configuration of the communication-apparatuses-between-the-points 1001 to 1003 is the same as the configuration in FIG. 6, the description will be omitted.

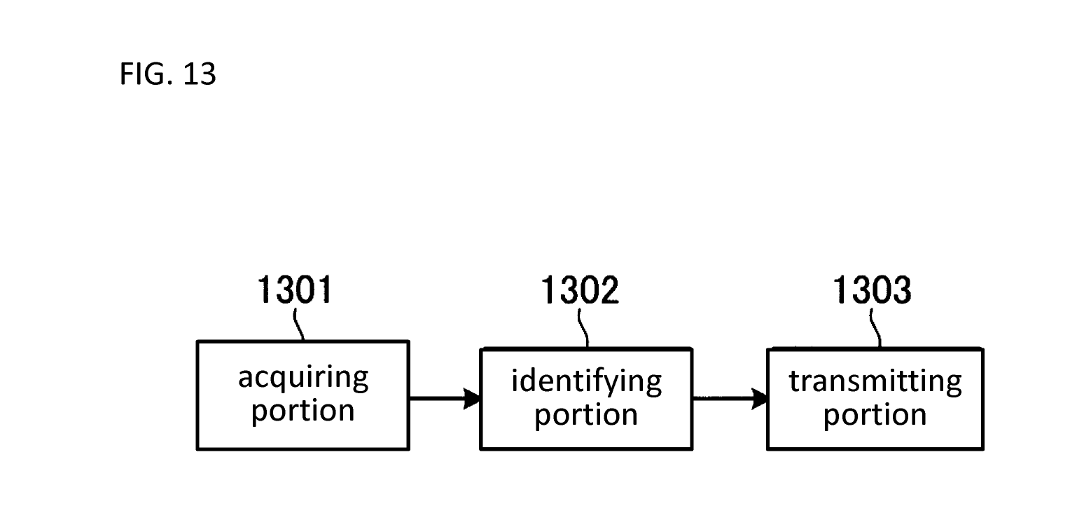

FIG. 13 is a block diagram illustrating a functional configuration of the communication-apparatuses-between-the-points 1001 to 1003 according to this embodiment. The communication-apparatuses-between-the-points 1001 to 1003 have a configuration including an acquiring portion 1301, an identifying portion 1302 and a transmitting portion 1303. The acquiring portion 1301, identifying portion 1302 and transmitting portion 1303 implement their functions by causing the CPU 601 to execute programs stored in the memory 602 illustrated in FIG. 6 or through the communication I/F 603.

The acquiring portion 1301 has a function of acquiring information on the entrance/exit point where the user has left and the entrance/exit point where the user will enter next among the neighboring entrance/exit points through communication with the mobile terminal within the communication area of the communication-apparatuses-between-the-points 1001 to 1003. More specifically, for example, when the IC card 200 carried by a user enters to the communication area of the communication-apparatuses-between-the-points 1001 to 1003, the point information on the entrance/exit point where the user has left (or exit point information) and the next-point information is received from the IC card 200 through non-contact communication between the communication-apparatuses-between-the-points 1001 to 1003 and the IC card 200.

The identifying portion 1302 has a function of identifying the information on the direction of travel from the current position of the mobile terminal to the entrance/exit point where the user will enter within the communication area of the communication-apparatuses-between-the-points 1001 to 1003 on the basis of the information acquired by the acquiring portion 1301. More specifically, for example, a combination of the received current-point information and next-point information provides the direction of travel by the user passing through the communication areas of the communication-apparatuses-between-the-points 1001 to 1003.

For example, in the example in FIG. 3, focusing on the communication-apparatus-between-the-points 1001, since the user travels from the exit point information (“bus stop: Nakahara Station”) to the next-point information (“subway: Nakahara Station”), the direction-of-travel information prompts the user to turn right as illustrated in FIG. 11. On the other hand, if the user travels from the exit point information (subway: Nakahara Station) to the next-point information (bus stop: Nakahara Station), the direction-of-travel information prompts the user to turn left. In this way, the direction-of-travel information according to a combination of the exit point information and the next-point information is read from the direction-of-travel information prestored in the memory 602.

The transmitting portion 1303 has a function of transmitting the information on the direction of travel identified by the identifying portion 1302 to the mobile terminal though the communication with the mobile terminal. More specifically, for example, the communication I/F 603 transmits the identified direction-of-travel information to the IC card 200 within the communication area. Thus, the IC card 200 receives the transmitted direction-of-travel information and displays it on the display screen 201 as illustrated in FIG. 11 or FIG. 12.

[Sequence between Communication-Apparatuses-between-the-Points 1001 to 1003 and IC Card 200]

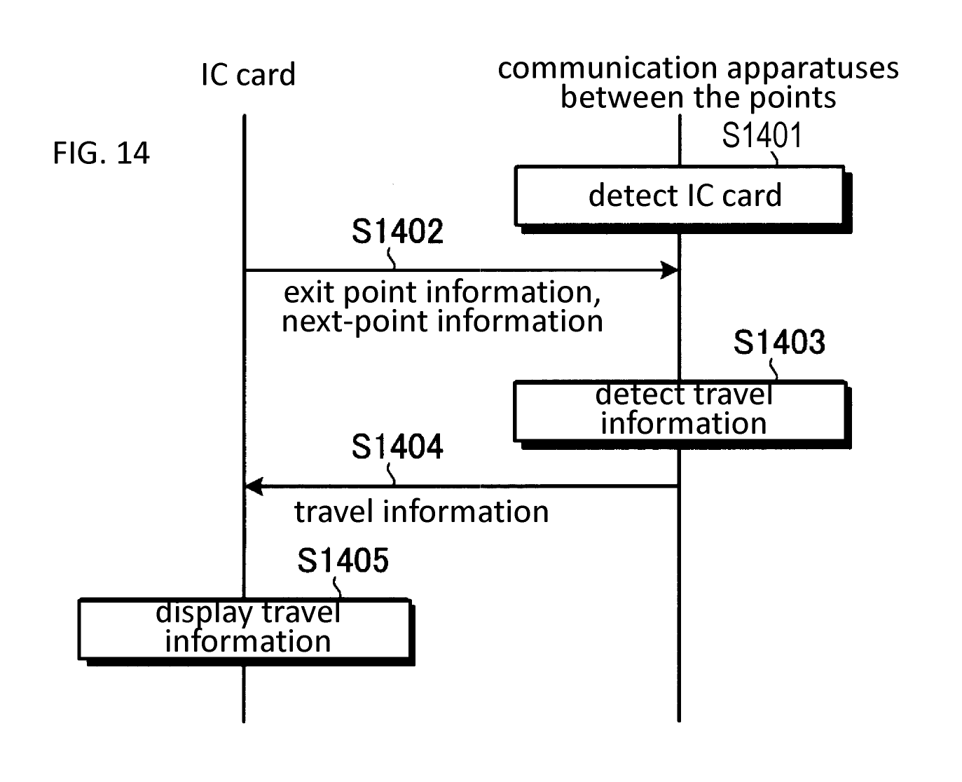

FIG. 14 is an explanatory diagram illustrating a sequence between the communication-apparatus-between-the-points 1001 to 1003 and the IC card 200 according to this embodiment. First of all, one of the communication-apparatuses-between-the-points 1001 to 1003 detects the IC card 200 within its communication area (step S1401). Thus, non-contact communication is performed between the corresponding one of the communication-apparatuses-between-the-points 1001 to 1003 and the IC card 200, and the IC card 200 transmits a combination of the exit point information and next-point information to the corresponding one of the communication-apparatuses-between-the-points 1001 to 1003 (step S1402). If the corresponding one of the communication-apparatuses-between-the-points 1001 to 1003 receives the combination of the exit point information and next-point information from the IC card 200, the direction-of-travel information according to the received combination of the exit point information and next-point information is identified (step S1403).

Then, the direction-of-travel information is transmitted to the IC card 200 (step S1404). The IC card 200 receives the direction-of-travel information transmitted from the corresponding one of the communication-apparatuses-between-the-points 1001 to 1003, saves it in the memory 502, and displays it on the display screen 201 (step S1405). Thus, even on the route from the entrance/exit point where a user has left to the next entrance/exit point, the guidance for the user may be aided. The user may acquire necessary information automatically without any operations to input. Therefore, information supply services with high convenience to users may be provided.

As described above, according to this embodiment, information required when a user changes the transportation system may be provided to the user without any loads on the user. More specifically, when a user brings the IC card 200 into contact with an automatic ticket gate in a station and leaves, the map from the station that the user has left to the station or bus stop that the user will enter next is displayed on the IC card 200. Thus, the user is only required to pass through the automatic ticket gate to acquire the map, without any operations.

Having described according to the embodiment that the IC card 200 is used as a mobile terminal of a user, for example, the mobile terminal may be a mobile terminal having at least one function of a telephone function, an electronic mail function, a Web browser function, a game function and a video playing function, such as a cellular phone, a smartphone and a portable game machine. Since the mobile terminal has a display for functions such as a telephone function, an electronic mail function, a Web browser function, a game function, and a video playing function, the display may be used as an information display of this embodiment.

Regarding the embodiment, the following appendices will further be disclosed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable medium for storing information display programs causing a computer communicating with a communication apparatus provided at the entry or exit at an entrance/exit point where a user gets on or off a transportation system to perform a display method, the display method comprising:
detecting that the user has left the exit of the current entrance/exit point through the communication between a communication apparatus provided at the exit of the current entrance/exit point where the computer is within the communication area and the computer, among the communication apparatuses provided at the exits of the entrance/exit points within a route through the entrance/exit points;
identifying the next entrance/exit point to the current entrance/exit point among the entrance/exit points within the route, if the detecting that the user has left the current entrance/exit point is performed by the computer;
acquiring map showing the route from the current entrance/exit point to the next entrance/exit point identified by the identifying the next entrance/exit point to the current entrance/exit point among the entrance/exit points within the route through the communication between the communication apparatus provided at the exit of the current entrance/exit point and the computer; and
controlling a display screen of the computer so as to display the map showing the route from the current entrance/exit point to the next entrance/exit point acquired by the acquiring map showing the route from the current entrance/exit point to the next entrance/exit.

2. The computer readable medium for storing information display programs according to claim 1, wherein the acquiring map showing the route from the current entrance/exit point to the next entrance/exit point is performed to acquire information on the direction of travel of the user at the position of a specific communication-apparatus-between-the-points through the communication between the specific communication-apparatus-between-the-points having the computer within the communication area and the computer, among the communication-apparatuses-between-the-points present between the current entrance/exit point and the next entrance/exit point; and
controlling the display screen of the computer so as to display the map showing the route from the current entrance/exit point to the next entrance/exit point acquired by displaying the information on the direction of travel.

3. The computer readable medium for storing information display programs according to claim 1, the display method comprising:
deleting the information from a memory within the computer, the information acquired by the acquiring map showing the route from the current entrance/exit point to the next entrance/exit point identified, wherein:
the acquiring map showing the route from the current entrance/exit point to the next entrance/exit point identified is performed by acquiring map showing the route from the last entrance/exit point before the current entrance/exit point to the current entrance/exit point prior to the map showing the route from the current entrance/exit point to the next entrance/exit point; and
the deleting the information from a memory within the computer is performed by deleting the map showing the route from the last entrance/exit point to the current entrance/exit point from the memory before the map showing the route from the current entrance/exit point to the next entrance/exit point is displayed on the display screen.

4. The computer readable medium for storing information display programs according to claim 2, the display method comprising:
deleting the information from a memory within the computer, the information acquired by the acquiring map showing the route from the current entrance/exit point to the next entrance/exit point identified, wherein:
the acquiring map showing the route from the current entrance/exit point to the next entrance/exit point identified is performed by acquiring map showing the route from the last entrance/exit point before the current entrance/exit point to the current entrance/exit point prior to the map showing the route from the current entrance/exit point to the next entrance/exit point; and
the deleting the information from a memory within the computer is performed by deleting the map showing the route from the last entrance/exit point to the current entrance/exit point from the memory before the map showing the route from the current entrance/exit point to the next entrance/exit point is displayed on the display screen.

5. An information display apparatus communicating with a communication apparatus provided at the entry or exit at an entrance/exit point where a user gets on or off a transportation system, the information display apparatus comprising:
detector for detecting that the user has left the exit of the current entrance/exit point through the communication between a communication apparatus provided at the exit of the current entrance/exit point where the computer is within the communication area and the computer, among the communication apparatuses provided at the exits of the entrance/exit points within a route through the entrance/exit points;
identifier, if the detector detects that the user has left the current entrance/exit point, for identifying the next entrance/exit point to the current entrance/exit point among the entrance/exit points within the route;
acquirer for acquiring map showing the route from the current entrance/exit point to the next entrance/exit point identified by the identifying means through the communication between the communication apparatus provided at the exit of the current entrance/exit point and the computer; and
display controller for controlling a display screen of the computer so as to display the map showing the route from the current entrance/exit point to the next entrance/exit point acquired by the acquirer.

6. The information display apparatus according to claim 5, wherein the information display apparatus is a card-shaped mobile terminal without a backlight for the display screen.

7. The information display apparatus according to claim 5, wherein the information display apparatus is a card-shaped mobile terminal at least partially having a touch panel on the display screen.

8. The information display apparatus according to claim 6, wherein the information display apparatus is a card-shaped mobile terminal at least partially having a touch panel on the display screen.

9. An information display method which is performed by a computer communicating with a communication apparatus provided at the entry or exit at an entrance/exit point where a user gets on or off a transportation system, the information display method comprising:
detecting that the user has left the exit of the current entrance/exit point through the communication between a communication apparatus provided at the exit of the current entrance/exit point where the computer is within the communication area and the computer, among the communication apparatuses provided at the exits of the entrance/exit points within a route through the entrance/exit points;
identifying the next entrance/exit point to the current entrance/exit point among the entrance/exit points within the route, if the detecting that the user has left the current entrance/exit point is performed by the computer communicating;
acquiring map showing the route from the current entrance/exit point to the next entrance/exit point identified by the identifying the next entrance/exit point to the current entrance/exit point among the entrance/exit points within the route through the communication between the communication apparatus provided at the exit of the current entrance/exit point and the computer; and
controlling a display screen of the computer so as to display the map showing the route from the current entrance/exit point to the next entrance/exit point acquired by the acquiring map showing the route from the current entrance/exit point to the next entrance/exit.
